(19) United States
(12) Patent Application Publication
(10) Pub. No.: US 2017/0146800 A1
(43) Pub. Date: May 25, 2017

(54) SYSTEM AND METHOD FOR FACILITATING CROSS-CHECKING BETWEEN FLIGHT CREW MEMBERS USING WEARABLE DISPLAYS

(71) Applicant: Gulfstream Aerospace Corporation, Savannah, GA (US)

(72) Inventor: Michael Knight, Savannah, GA (US)

(21) Appl. No.: 14/948,453

(22) Filed: Nov. 23, 2015

(51) Int. Cl. G02B 27/01; B64D 11/00; G06F 3/01

(52) U.S. Cl. CPC G02B 27/0172; G06F 3/012; B64D 11/00; G02B 2027/014; G02B 2027/0141

(57) ABSTRACT

A system for facilitating instrument cross-checks between aircrew members using wearable displays includes, but is not limited to, first and second wearable displays configured to be worn by a first and second aircrew members, respectively, and first and second sensors configured to detect first and second orientations of the wearable displays, and a processor coupled with the first sensor, the second sensor, the first wearable display and the second wearable display. The processor is configured to obtain the first and second orientations from the first and second sensors, respectively, and to control the first wearable display to display a first image to the first crew member, and to control the second wearable display to display a second image to the second crew member, and to control the first wearable display to display the second image to the first crew member when the first orientation comprises a first predetermined orientation.

### TECHNICAL FIELD

The present invention generally relates to aviation, and more particularly relates to a system and method for facilitating crosschecking between flight crew members using wearable displays.

### BACKGROUND

Regulations promulgated by the Federal Aviation Administration and governing bodies in other jurisdictions require that the pilot and the co-pilot of an aircraft each engage in the practice of cross-checking their displays with one another. A cross-check is a procedure by which the pilot and the co-pilot each verify that certain information presented on their respective display screens is accurate. The cross-check entails the pilot and the co-pilot each viewing the other's display screen and comparing the information presented on their own display screen with the information presented on the display screen of their counter-part. Because the pilot's display and the co-pilot's display are each displaying information originating from different sensors and/or different sources, the cross-check is an important and reliable way to confirm the accuracy of the information being displayed.

Innovations in aviation have led to flight decks where instead of having stationary display screens mounted in instrument panels, pilots can now wear wearable displays and view flight related information on near-to-eye displays. For example, in a modern flight deck, the pilot may wear the display screen on their head. Head worn display screens may come in various forms such as a helmet mounted display, a visor display, a goggle display, a monocle display, and the like. While this new way of displaying information to the pilot provides many advantages, it also renders the conventional method of performing a cross-check obsolete because the near-to-eye display screen of each wearable display is only viewable to the aircrew member who is wearing it.

Accordingly, it is desirable to provide an apparatus and a method that permits pilots wearing a wearable display to engage in cross-checks with their fellow crew members. Furthermore, other desirable features and characteristics will become apparent from the subsequent summary and detailed description and the appended claims, taken in conjunction with the accompanying drawings and the foregoing technical field and background.

### BRIEF SUMMARY

Various embodiments of systems and methods for facilitating cross-checks between aircrew members using wearable displays are disclosed herein.

In a first non-limiting embodiment, the system includes, but is not limited to, a first wearable display configured to be worn by a first aircrew member. The system further includes, but is not limited to, a second wearable display configured to be worn by a second aircrew member. The system further includes, but is not limited to, a first sensor configured to detect a first orientation of the first wearable display. The system further includes, but is not limited to, a second sensor configured to detect a second orientation of the second wearable display. The system still further includes, but is not limited to, a processor communicatively coupled with the first sensor, the second sensor, the first wearable display and the second wearable display. The processor is configured to obtain the first orientation from the first sensor, to obtain the second orientation from the second sensor, to control the first wearable display to display a first image to the first crew member, to control the second wearable display to display a second image to the second crew member, and to control the first wearable display to display the second image to the first crew member when the first orientation comprises a first predetermined orientation.

In another non-limiting embodiment, the system includes, but is not limited to, a first wearable display configured to be worn by a first aircrew member. The system further includes, but is not limited to, a second wearable display configured to be worn by a second aircrew member. The system further includes, but is not limited to, a sensor configured to detect a first orientation of the first wearable display and to detect a second orientation of the second wearable display. The system still further includes, but is not limited to, a processor communicatively coupled with the sensor, the first wearable display and the second wearable display. The processor is configured to obtain the first orientation and the second orientation from the sensor, to control the first wearable display to display a first image to the first crew member, to control the second wearable display to display a second image to the second crew member, and to control the first wearable display to display the second image to the first crew member when the first orientation comprises a first predetermined orientation.

In another non-limiting embodiment, the method includes, but is not limited to, the step of detecting a first orientation of a first wearable display and a second orientation of a second wearable display. The method further includes, but is not limited to, the step of providing the first orientation and the second orientation to a processor. The method further includes, but is not limited to, the step of controlling, with the processor, the first wearable display to display a first image and the second wearable display to display a second image. The method still further includes, but is not limited to, the step of controlling, with the processor, the first wearable display to display the second image when the first orientation comprises a first predetermined orientation.

### BRIEF DESCRIPTION OF THE DRAWINGS

The present invention will hereinafter be described in conjunction with the following drawing figures, wherein like numerals denote like elements, and

FIG. 1 is a block diagram illustrating a non-limiting embodiment of a system for facilitating cross-checking between flight crew members using wearable displays;

FIG. 1A is a block diagram illustrating a non-limiting alternate embodiment of the system of FIG. 1;

FIG. 2 is a perspective view illustrating a non-limiting embodiment of a visor compatible for use with the system of FIG. 1;

FIG. 3 is a perspective view illustrating a non-limiting embodiment of a pair of goggles compatible for use with the system of FIG. 1;

FIG. 4 is a perspective view illustrating a non-limiting embodiment of a monocle compatible for use with the system of FIG. 1;

FIG. 5 is a perspective view of a flight deck equipped with a non-limiting embodiment of a helmet mounted sensor for detecting an orientation of a wearable display and the corresponding sight line of an aircrew member, the helmet mounted sensor being compatible for use with the system of FIG. 1;

FIG. 6 is a perspective view of a flight deck equipped with a non-limiting embodiment of a magnetic field sensor for detecting the orientation of the wearable display and the corresponding sight line of the aircrew member, the magnetic field sensor being compatible for use with the system of FIG. 1;

FIG. 7 is a perspective view of a flight deck equipped with a non-limiting embodiment of a video camera for detecting the orientation of the wearable display and the corresponding sight line of the aircrew member, the video camera being compatible for use with the system of FIG. 1;

FIG. 8 is a perspective view of a pilot and a co-pilot seated at a flight deck equipped with the system of FIG. 1, prior to cross-checking;

FIG. 9 is a representation of a pilot's view through a wearable display prior to cross-checking;

FIG. 10 is a perspective view of the pilot and the co-pilot seated at the flight deck of FIG. 8 as the pilot cross-checks his/her display against the co-pilot's display;

FIG. 11 is a representation of the pilot's view through the wearable display as he/she cross-checks his/her display against the co-pilot's display;

FIG. 12 is a perspective view of the pilot and the co-pilot seated at the flight deck of FIG. 8 as the co-pilot cross-checks his/her display against the pilot's display;

FIG. 13 is a representation of the co-pilot's view through the wearable display as he/she cross-checks his/her display against the pilot's display; and

FIG. 14 is a flow diagram illustrating a non-limiting embodiment of a method for facilitating crosschecking between flight crew members using wearable displays.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

Various non-limiting embodiments of a system and a method for facilitating cross-checking between aircrew members are disclosed herein. The system includes a first wearable display configured to be worn on the upper body or head of a first aircrew member (e.g., the pilot) and a second wearable display configured to be worn on the upper body or head of a second aircrew member (e.g., the co-pilot). Each wearable display includes a near-to-eye screen that presents images (graphics or text or both) to the aircrew member wearing the wearable display. By presenting the aircrew member with a display screen in close proximity to the aircrew member's eye, a full size display screen that would typically be mounted in the instrument panel directly in front of the aircrew member can be eliminated entirely and the space that it would have otherwise occupied can be used for other purposes.

The system also includes first and second sensors for detecting the orientation of the wearable display and, by extension, the sight line of the aircrew member. As used herein, the term “orientation”, when used in reference to a wearable display, refers to the height and attitude of the wearable display with reference to the flight deck where it is being employed. As used herein, the term “sight line” refers to the direction where the aircrew member's vision is focused. In some embodiments, the sight line is presumed based on the orientation of the wearable display. In other embodiments, the sensor may be configured to observe the aircrew member's eyes to detect the sight line. Once the processor knows the aircrew member's site line, the processor can determine the location where the pilot is focusing his or her vision.

The system further includes a processor that receives information from the first and second sensors that is indicative of the orientation of the first and second wearable displays. Using this information, the processor is configured to detect where each aircrew member is looking and possibly what each aircrew member is focusing on. The processor is further configured to control each wearable display to display information to each aircrew member. For example, the processor may be configured to control each wearable display to display flight related information to the pilot such as the aircraft's heading, altitude, and velocity. Any other suitable graphic/image/text may also be displayed to each aircrew member without departing from the teachings of the present disclosure. The processor may be configured to maintain this image on each wearable display until one or both aircrew members engages in a cross-check.

When the processor determines that the orientation of the aircrew member's wearable display is equal to a predetermined orientation, the processor is configured to facilitate cross-checking. In some embodiments, when the orientation of the wearable display equals the predetermined orientation, the processor is configured to display to the aircrew member information/images that are currently being displayed to the other crew member. This will allow the crew member to compare his or her own information with the information being presented to the other crew member. The predetermined orientation is one that will result in a sight line that intercepts a predetermined location in the flight deck. In an example, if the aircrew member orients his or her head in a manner that would permit that aircrew member to view the location on the instrument panel directly in front of the other aircrew member (i.e., the location where a conventional display screen would be located in a conventional flight deck), then the processor will conclude that the aircrew member wants to perform a cross-check and will display the information to the aircrew member that is currently being presented to the other aircrew member.

A greater understanding of the system described above and of a method for facilitating cross-checking between aircrew members using wearable displays may be obtained through a review of the illustrations accompanying this application together with a review of the detailed description that follows.

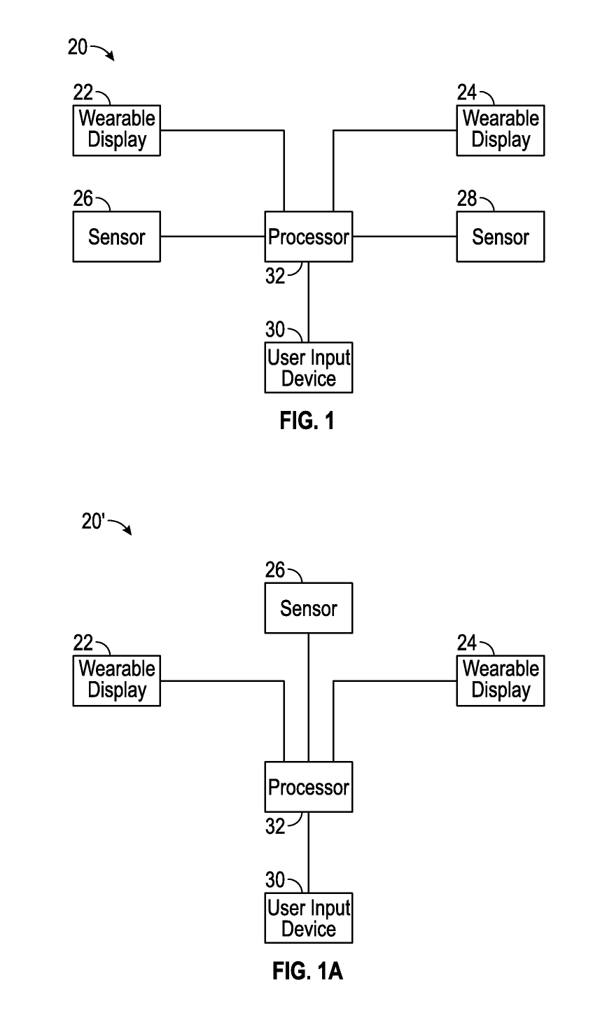

FIG. 1 is a block diagram illustrating a non-limiting embodiment of a system 20 for facilitating cross-checking between aircrew members using wearable displays. System 20 includes a wearable display 22, a wearable display 24, a sensor 26, a sensor 28, a user input device 30, and a processor 32. In other embodiments, system 20 may include a greater or a small number of components without departing from the teachings of the present disclosure.

Wearable displays 22 and 24 may comprise any suitable wearable display now known, or hereafter developed. Wearable displays for use in the field of aviation are well known in the art. Wearable displays 22 and 24 each comprise a display that presents an image to an aircrew member in a near-to-eye manner. Wearable displays 22 and 24 may comprise helmet mounted displays or they may comprise standalone apparatuses worn by aircrew members either underneath a helmet or without a helmet. Some known wearable displays include visors, goggles, and monocles.

In some embodiments, wearable displays 22 and 24 may replace conventional primary flight displays. In those embodiments, all of the information that is currently provided to an aircrew member by a primary flight display will be presented to the aircrew member in near-to-eye fashion. For example, information such as aircraft attitude, airspeed, altitude, height above terrain, heading, navigation or guidance cues, alerts, warnings, system status, and the like may be displayed to an aircrew member via wearable displays 22 and 24. This would provide the aircrew member with the advantage of having constant access to this information regardless of where his or her head was facing and without the need to direct his or her gaze to a specific location on the instrument panel. Furthermore, by eliminating the primary flight display from the instrument panel in front of each aircrew member, the vacated space can be used for other purposes.

Sensors 26 and 28 may comprise any suitable sensor configured to determine the orientation of wearable displays 22 and 24. In some non-limiting embodiments, sensors 26 and 28 may comprise gyroscopes or accelerometers mounted in wearable displays 26 and 28. In other embodiments, sensors 26 and 28 may comprise sensors configured to detect magnetic fields generated by magnets mounted to wearable displays 22 and 24 and further configured to detect variations in the magnetic fields caused by movement or changes in the orientation of the magnets. In other embodiments, sensors 26 and 28 may comprise video cameras mounted in a flight deck and positioned/configured to monitor the movements of wearable displays 22 and 24. In other embodiments, sensors 26 and 28 may comprise any suitable combination of any of the foregoing sensors and/or may include any additional suitable sensor(s).

User input device 30 may be any component suitable to receive inputs from an aircrew member. For example, and without limitation, user input device 30 may be a keyboard, a mouse, a touch screen, a tablet and stylus, a button, a switch, a toggle switch, a spring loaded toggle switch, a knob, a slide, a microphone, a camera, a motion detector, or any other device that is configured to permit a human to provide inputs into an electronic system.

Processor 32 may be any type of onboard computer, controller, micro-controller, circuitry, chipset, computer system, or microprocessor that is configured to perform algorithms, to execute software applications, to execute sub-routines and/or to be loaded with, and to execute, any other type of computer program. Processor 32 may comprise a single processor or a plurality of processors acting in concert. In some embodiments, processor 32 may be dedicated for use exclusively with system 20 while in other embodiments processor 32 may be shared with other systems on board the aircraft where system 20 is employed.

Processor 32 is coupled with wearable display 22, wearable display 24, sensor 26, sensor 28, and user input device 30. Such coupling may be accomplished through the use of any suitable means of transmission including both wired and wireless connections. For example, each component may be physically connected to processor 32 via a coaxial cable or via any other type of wired connection effective to convey signals. In the illustrated embodiment, processor 32 is directly connected to each of the other components. In other embodiments, each component may be coupled to processor 32 across a vehicle bus. In still other examples, each component may be wirelessly connected to processor 32 via a Bluetooth connection, a WiFi connection or the like.

Being coupled as described above provides a pathway for the transmission of commands, instructions, interrogations and other signals between processor 32 and each of the other components of system 20. Through this coupling, processor 32 may control and/or communicate with each of the other components. Each of the other components discussed above is configured to interface and engage with processor 32. For example, in some embodiments, wearable display 22 and wearable display 24 may each be configured to receive commands from processor 32 and to display text and/or graphical images in response to such commands In some embodiments, sensor 26 and sensor 28 may be configured to automatically provide information relating to the orientation of wearable display 22 and wearable display 24, respectively, to processor 32 at regular intervals or in response to an interrogation received from processor 32. In some embodiments, user input device 30 may be configured to convert operator actions and/or movements into electronic signals and to communicate such signals to processor 32.

Processor 32 may be programmed and/or otherwise configured to receive information originating from various flight-related sensors onboard the aircraft where system 20 is implemented. The flight-related sensors collect information and/or data relating to the state of the aircraft in flight. Processor 32 is configured to utilize the information provided by such flight-related sensors to control wearable display 22 and wearable display 24 to present images to the aircrew members that communicate the state of the aircraft. For example, the information provided by the flight-related sensors may relate to the heading, flight level, and velocity of the aircraft and upon receipt of this information, processor 32 will control wearable display 22 and wearable display 24 to display the aircraft's heading, flight level and velocity to each aircrew member.

In some embodiments, processor 32 receives redundant information from different and disparate flight-related sensors. For example, there may be multiple flight-related sensors onboard the aircraft that are configured to detect the heading, or to detect the flight level, or to detect the velocity of the aircraft. The data originating from one set of flight-related sensors may be used by processor 32 to control the images displayed by wearable display 22 while the data originating from a different set of flight-related sensors may be used by processor 32 to control the images displayed by wearable display 24. In this manner, processor 32 uses the information originating from a first set of flight-related sensors to generate a first set of flight-related images that are associated with wearable display 22 and processor 32 uses the information originating from a second set of flight-related sensors that are different in kind from the first set of flight related sensors to generate a second set of flight-related images that are associated with wearable display 24. The use of different and disparate flight-related sensors enhances flight safety in instances of a sensor malfunction by providing an alternate type of sensor to provide the same information.

When the aircrew members perform a cross check, they are each seeking to view the flight-related information being presented to the other aircrew member for the purpose of comparing it with the flight-related information that they are being presented with. Processor 32 is configured to interact with, coordinate and/or orchestrate the activities of each of the components of system 20 for the purpose of facilitating each aircrew member's ability to perform cross checks. Processor 32 is configured to receive information from sensor 26 relating to the orientation of wearable display 22. Similarly, processor 32 is also configured to receive information from sensor 28 relating to the orientation of wearable display 24. Such information may be obtained continuously, periodically, or anytime there is a change in orientation of either or both wearable displays 22 and 24. In this manner, a real-time or current orientation (“orientation”) of each of wearable display 22 and 24 can be obtained.

Processor 32 is configured to interpret the information provided by sensors 26 and 28 to determine the orientation of wearable displays 22 and 24. Processor 32 is further configured to compare the orientation with a predetermined orientation. The predetermined orientation is one which will cause the aircrew member's sight line to intercept a predetermined location in the flight deck. In an embodiment, the predetermined location for one of the aircrew members may be a region on an instrument panel located directly in front of the other aircrew member, and vice versa. In that case, the predetermined orientation is one which will cause the aircrew member's sight line to intercept the region on the instrument panel located directly in front of the other aircrew member. This arrangement will feel natural for aircrew members who were trained or experienced in operating aircraft that lack wearable displays. In other embodiments, the predetermined orientation may be one which will cause an aircrew member's sight line to intercept any other desired predetermined location in the flight deck.

When processor 32 determines that the orientation of wearable display 22 differs from a first predetermined orientation associated with wearable display 22, then processor 32 will continue to control wearable display 22 to display the first set of flight-related images. Similarly, when processor 32 determines that the orientation of wearable display 24 differs from a second predetermined orientation, then processor 32 will continue to control wearable display 24 to display the second set of flight-related images.

When processor 32 determines that the orientation of wearable display 22 is equal to the first predetermined orientation, then processor 32 will control wearable display 22 to display the second set of flight-related images. Similarly, when processor 32 determines that the orientation of wearable display 24 equals the second predetermined orientation, then processor 32 will control wearable display 24 to display the first set of flight-related images. In this manner, each aircrew member may perform a cross-check simply by looking in the direction of the predetermined location in the flight deck. In some embodiments, when processor 32 determines that the orientation equals the predetermined orientation, processor 32 may control the respective wearable display to display both the first and second set of flight-related images, while in other embodiments, processor 32 may be configured to control the respective wearable display to discontinue display of one set of flight-related images and to begin display of the other set of flight-related images. When the aircrew member looks away from the predetermined location, processor 32 will determine that the orientation of the wearable display is no longer equal to the predetermined orientation and will control the wearable display to discontinue display of the other aircrew member's set of flight-related images.

In some embodiments, user input device 30 may be utilized by an aircrew member to enable or disable the ability of system 20 to facilitate cross-checking. In one example, an aircrew member must actuate user input device 30 in order for system 20 to facilitate cross-checks. This may be desirable in instances where an aircrew member anticipates that he or she will be directing his or her sight line to the predetermined location for reasons other than performing a cross-check and would prefer not to have the other flight crew member's flight-related information presented in his or her wearable display on such occasions. In another example, user input device 30 may be used by an aircrew member to temporarily disable the ability of system 20 to facilitate cross-checks. This arrangement may also be useful in circumstances where one flight crew member wants to view the predetermined location without seeing the other flight crew member's flight-related information.

With continuing reference to FIG. 1, FIG. 1A illustrates a system 20′. System 20′ is an alternate embodiment of system 20. System 20′ utilizes only a single sensor (sensor 26) as compared with system 20 which utilizes two sensors (sensor 26 and sensor 28). System 20′ performs in a substantially identical manner to system 20 except that system 20′ uses a single sensor to detect the orientation of both wearable display 22 and wearable display 24. Processor 32 obtains information from sensor 26 relating to the orientation of both wearable display 22 and wearable display 24 and utilizes this information in the same manner described above with respect to system 20.

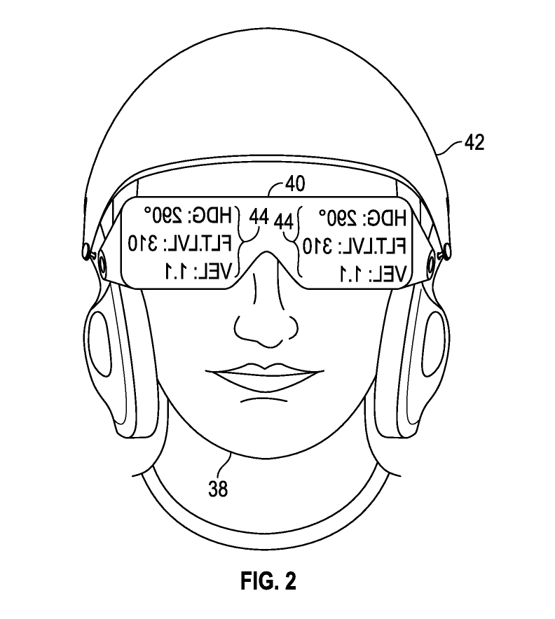

With continuing reference to FIG. 1, FIGS. 2-4 are perspective views illustrating various embodiments of wearable displays compatible for use with system 20. Each embodiment comprises a type of near-to-eye display.

FIG. 2 illustrates a visor 40, mounted to a helmet. Visor 40 is pivotally mounted to a helmet 42 that is worn by an aircrew member 38. An image 44 conveying flight related data is displayed in visor 40 and is projected in front of both eyes of aircrew member 38 to provide aircrew member 38 with a stereoscopic view. In some embodiments, visor 40 presents image 44 to aircrew member 38 in a manner having an appearance similar to that of a head-up display. For example, in some embodiments, visor 40 is transparent and image 44 appears to be overlaid on top of the aircrew member's view of everything falling within his or her sight line.

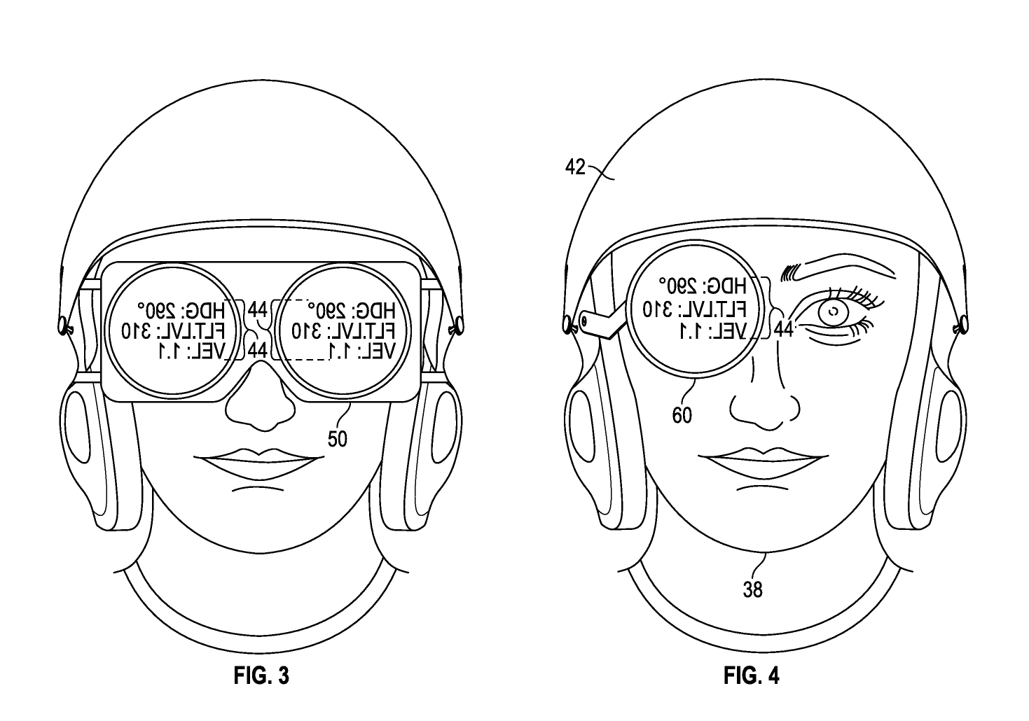

FIG. 3 illustrates a pair of goggles 50 configured to be worn directly on the head of aircrew member 38. As with visor 40, pair of goggles 50 also projects image 44 of the flight related data to both eyes of aircrew member 38 to provide a stereoscopic view.

FIG. 4 illustrates a monocle 60 pivotally mounted to helmet 42 and positioned directly in front of one eye of aircrew member 38. Accordingly, monocle 60 presents image 44 of the flight related data to only one eye of aircrew member 38.

It should be understood by those of ordinary skill in the art that other types of wearable displays may be employed with system 20 without departing from the teachings of the present disclosure.

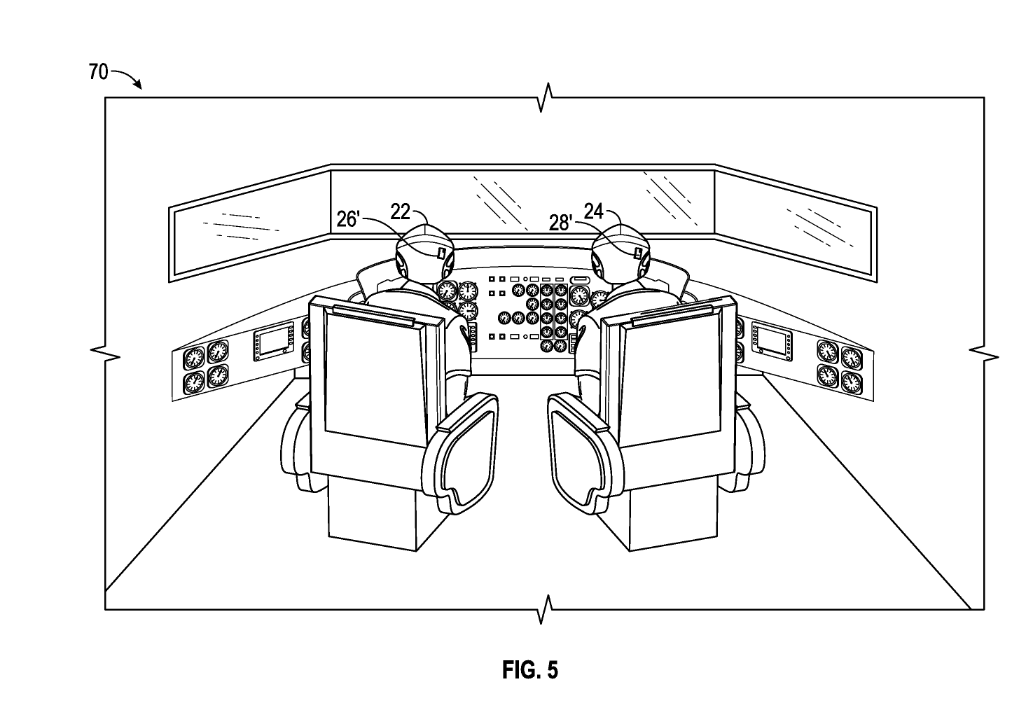

With continuing reference to FIGS. 1-4, FIG. 5 is a perspective view illustrating an exemplary embodiment of a flight deck 70 equipped with an embodiment of system 20. In this embodiment, system 20 employs a sensor 26′ and a sensor 28′. Sensor 26′ and sensor 28′ are each helmet mounted sensors that are integral with wearable display 22 and wearable display 24, respectively. In some embodiments, these sensors may comprise accelerometers while in alternate embodiments, these sensors may comprise gyroscopes. In still other embodiments, these sensors may comprise any other sensor configured to determine the orientation of the wearable display as the aircrew member turns and moves his or her head. In the illustrated embodiment, sensors 26′ and 28′ continuously monitor the orientation of the wearable display as the aircrew member moves his/her head and/or looks in various directions. Sensors 26′ and 28′ continuously provide information indicative of the orientation of wearable displays 22 and 24, respectively, to processor 32.

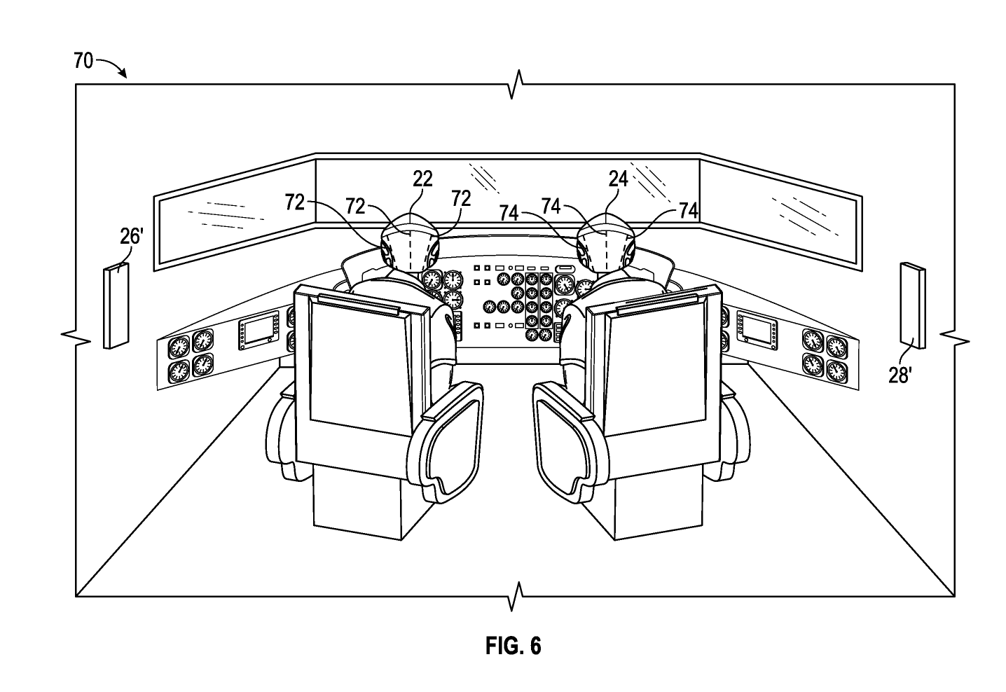

With continuing reference to FIGS. 1-5, FIG. 6 is a perspective view illustrating flight deck 70 equipped with another embodiment of system 20. In this embodiment, system 20 employs sensor 26′ and sensor 28′, both of which are magnetic field sensors. Sensors 26′ and 28′ are mounted to the inner surfaces (e.g., the walls) of flight deck 70 in close proximity to wearable display 22 and wearable display 24, respectively. Sensors 26′ and 28′ are configured to detect and measure the strength of the magnetic fields generated by magnets 72 and by magnets 74 mounted in wearable display 22 and wearable display 24, respectively. As each aircrew member moves and turns their head, the orientation of wearable displays 22 and 24 will change. This will cause corresponding changes to the magnetic fields generated by magnets 72 and 74. These changes in the magnetic fields will be detected by sensors 26′ and 28′ and provided to processor 32. Processor 32 is configured to correlate the changes in the respective magnetic fields with an orientation of wearable displays 22 and 24. In the illustrated embodiment, sensors 26′ and 28′ continuously monitor for changes to the magnetic fields produced by magnets 72 and 74 when the aircrew members moves their heads and/or look in various directions and continuously provide this information to processor 32.

In an alternate embodiment, system 20 may comprise only a single sensor (e.g., only sensor 26′ and omit sensor 28′). Such an arrangement is illustrated in FIG. 1A which depicts system 20′. In such an embodiment, sensor 26′ may be configured to simultaneously detect and measure the strength of the magnetic fields generated by magnets 72 and 74 and based on such strengths, to determine the orientation of both wearable displays 22 and 24.

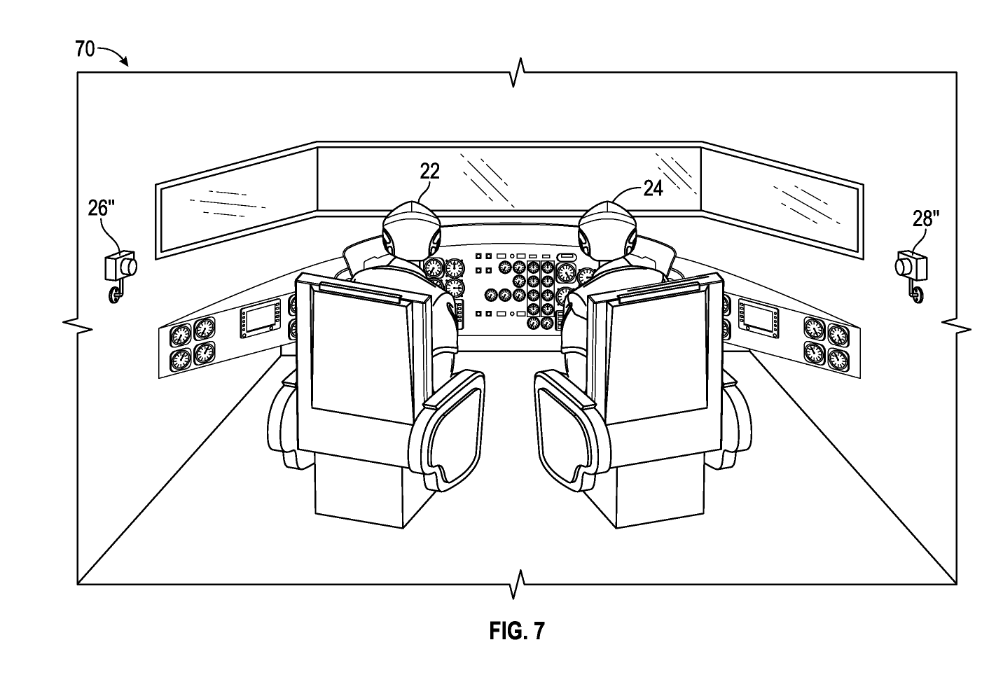

With continuing reference to FIGS. 1-6, FIG. 7 is a perspective view illustrating flight deck 70 equipped with another embodiment of system 20. In this embodiment, system 20 employs sensor 26″ and sensor 28″, both of which comprises video cameras. Sensors 26″ and 28″ are each mounted to the inner surfaces (e.g., walls) of flight deck 70 in close proximity to wearable display 22 and wearable display 24, respectively. Sensors 26″ and 28″ are configured to capture images of wearable displays 22 and 24, respectively. As each aircrew member moves and turns their head, the orientation of wearable displays 22 and 24 will change. This movement will be captured by sensors 26″ and 28″ and will be provided to processor 32. Processor 32 is configured to interpret the video feeds from sensors 26″ and 28″ and to use this information to determine the orientation of wearable displays 22 and 24. In the illustrated embodiment, sensors 26″ and 28″ continuously monitor for movement of wearable displays 22 and 24 as the aircrew members moves their heads and/or look in various directions and continuously provide their respective video feeds to processor 32.

In an alternate embodiment, system 20 may comprise only a single sensor (e.g., only sensor 26″ and omit sensor 28″). Such an arrangement is illustrated in FIG. 1A which depicts system 20′. In such an embodiment, sensor 26′ may be configured to simultaneously capture images of both wearable display 22 and wearable display 24 and based on such images, to determine the orientation of both wearable displays 22 and 24.

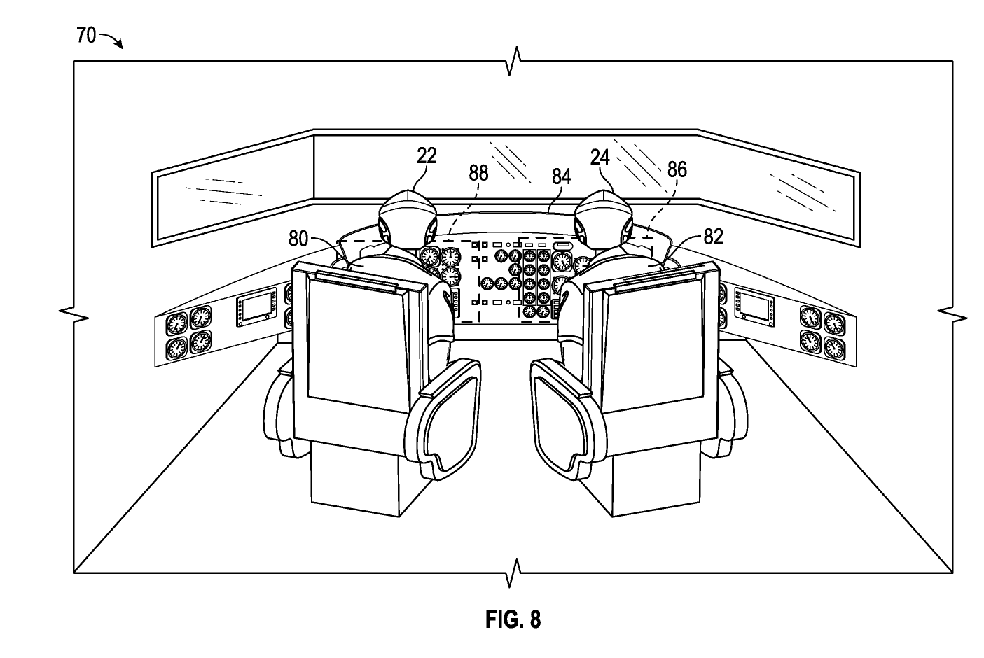

FIG. 8 depicts a pilot 80 and a co-pilot 82 seated in front of an instrument panel 84 in flight deck 70. Positioned directly in front of co-pilot 82 is a predetermined location 86 delineated in broken lines and positioned directly in front of pilot 80 is a predetermined location 88 delineated in broken lines. Predetermined locations 86 and 88 represent the regions of instrument panel 84 where a primary flight display would normally be positioned in a conventional flight deck. Because flight deck 70 utilizes system 20 and provides pilot 80 and co-pilot 82 with wearable displays 22 and 24, respectively, these regions of instrument panel 84 may be used to house items other than primary flight displays. In a conventional flight deck, pilot 80 would turn his/her head and look at predetermined location 86 when performing a cross check and co-pilot 82 would turn his/her head and look at predetermined location 88 when performing a cross-check. In the illustrated embodiment, when pilot 80 or co-pilot 82 turns their heads to look at predetermined locations 86 and 88, respectively, system 20 will interpret this conduct as an attempt by the aircrew member to perform a cross-check and will present the other aircrew member's flight related information to the aircrew member performing the cross-check. As illustrated in FIG. 8, pilot 80 is not looking at predetermined location 86 and co-pilot 82 is not looking at predetermined location 88. Accordingly, system 20 will interpret this as neither aircrew member attempting to perform a cross-check and, accordingly, will not present either aircrew member with the other aircrew member's flight-related information.

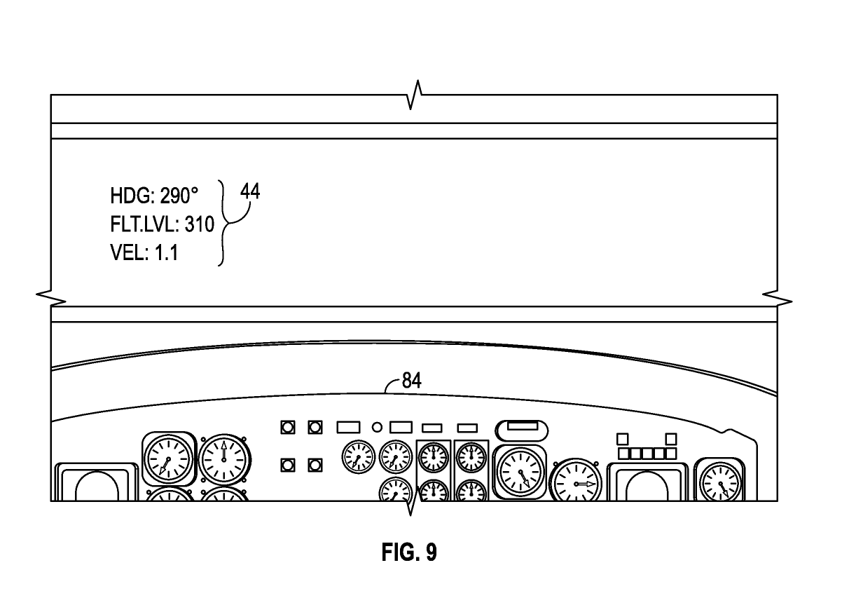

With continuing reference to FIGS. 1-8, FIG. 9 represents the view through wearable display 22, worn by pilot 80 of FIG. 8. As illustrated, image 44 containing flight-related information derived from a first set of flight-related sensors is presented in the pilot's field of view. Absent from the field of view of pilot 80 is any image containing the flight-related information that is being presented to co-pilot 82.

With continuing reference to FIGS. 1-9, FIG. 10 depicts pilot 80 and a co-pilot 82 seated in front of instrument panel 84 in flight deck 70, similar to FIG. 8. In this figure, pilot 80 has turned his/her head to look at predetermined location 86. When pilot 80 does this, system 20 detects that wearable display 22 is oriented at a predetermined orientation 90. This condition will cause a sight line 92 of pilot 80 to intercept predetermined location 86. Upon detecting this condition, processor 32 will cause wearable display 22 to display to pilot 80 an image containing the flight-related information currently being displayed to co-pilot 82.

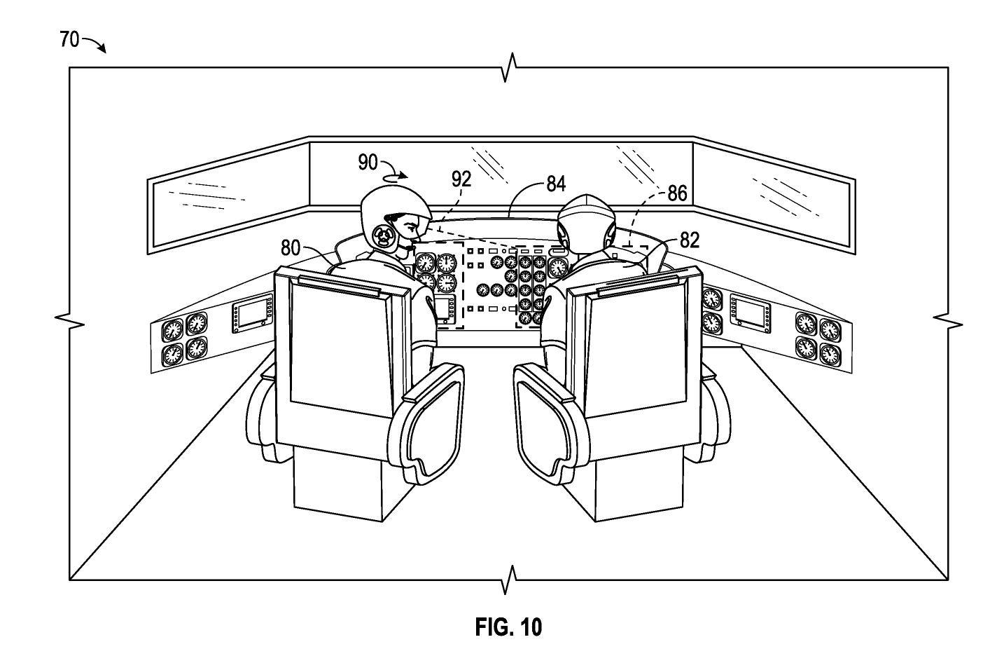

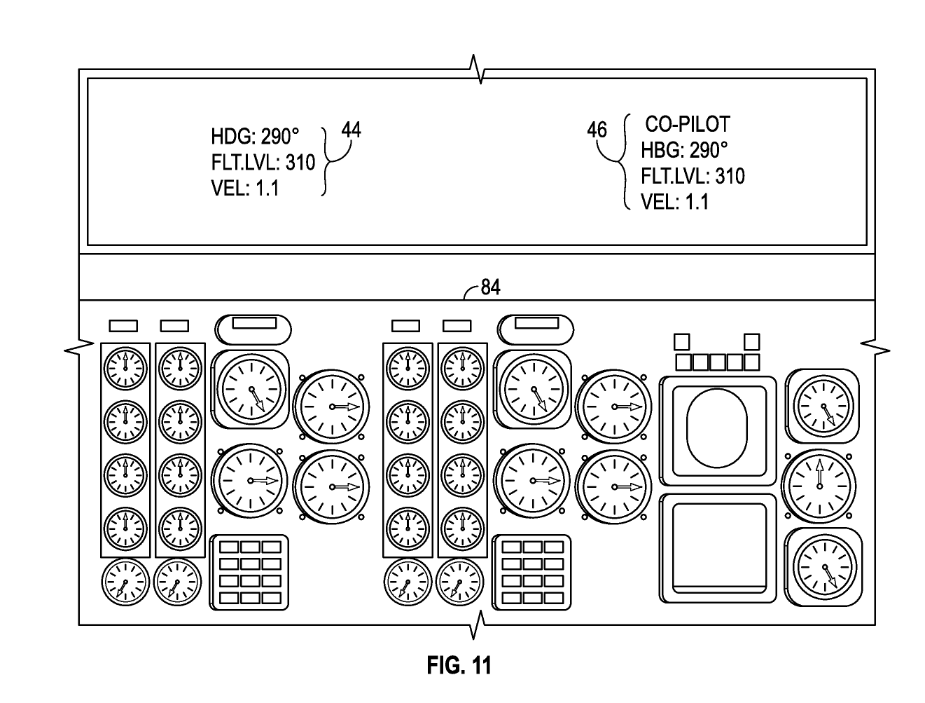

With continuing reference to FIGS. 1-10, FIG. 11 represents the view through wearable display 22, worn by pilot 80 of FIG. 10. As illustrated, image 44, which contains flight-related information derived from a first set of flight-related sensors remains displayed to pilot 80 by wearable display 22. In addition, an image 46 containing the flight related information being presented to co-pilot 82 is added to the display being presented to pilot 80 by wearable display 22. The illustrated side-by-side presentation makes it convenient for pilot 80 to complete the cross-check. In other embodiments, processor 32 may control wearable display 22 in a manner that causes it to temporarily discontinue displaying image 44 and to instead display image 46 while wearable display 22 is in the predetermined orientation. Other protocols are also possible without departing from the teachings of the present disclosure.

With continuing reference to FIGS. 1-11, FIG. 12 depicts pilot 80 and co-pilot 82 seated in front of instrument panel 84 in flight deck 70, similar to FIG. 10. Here, co-pilot 82 has turned his/her head to look at predetermined location 88. When co-pilot 82 does this, system 20 detects that wearable display 24 is oriented at a predetermined orientation 94 which will cause a sight line 96 of co-pilot 82 to intercept predetermined location 88. Upon detecting this condition, processor 32 will cause wearable display 24 to display to co-pilot 82 an image containing the flight-related information currently being displayed to pilot 80.

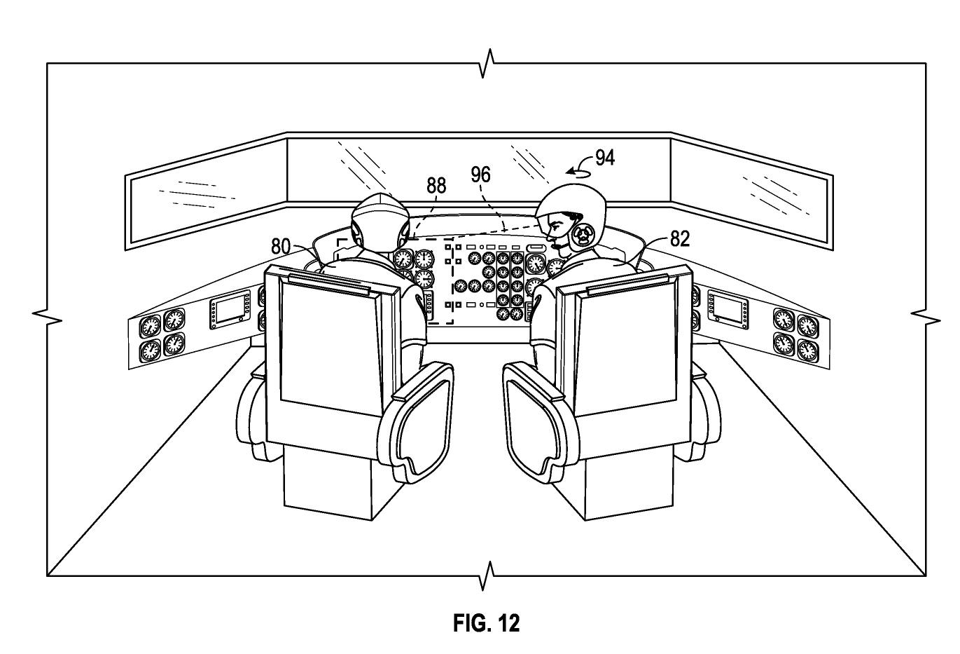

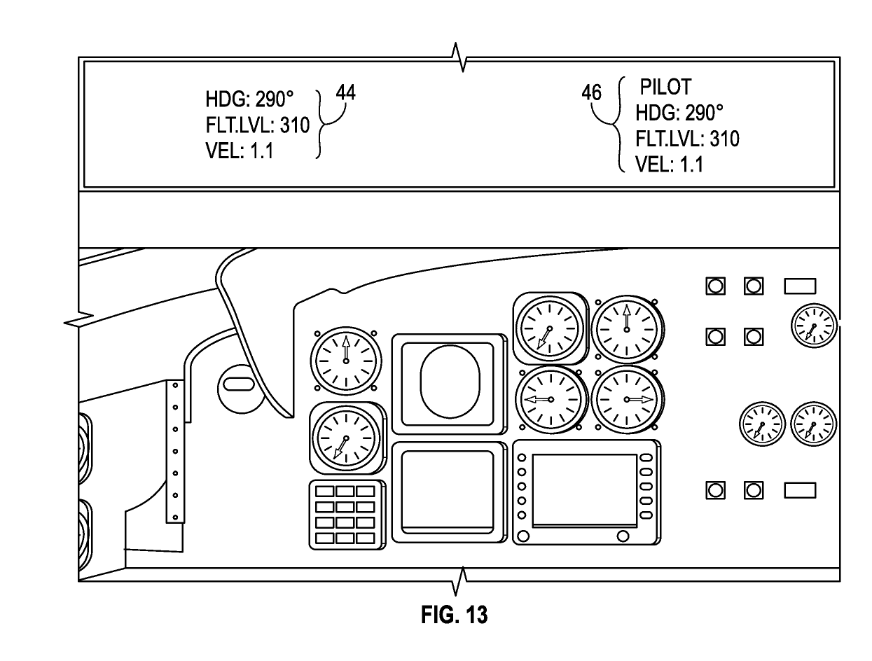

With continuing reference to FIGS. 1-12, FIG. 13 represents the view through wearable display 24, worn by co-pilot 82 of FIG. 12. As illustrated, image 46 containing flight-related information derived from a second set of flight-related sensors remains displayed by wearable display 24. In addition, image 44 containing flight related information being presented to pilot 80 is added to the display to facilitate cross-checking by co-pilot 82.

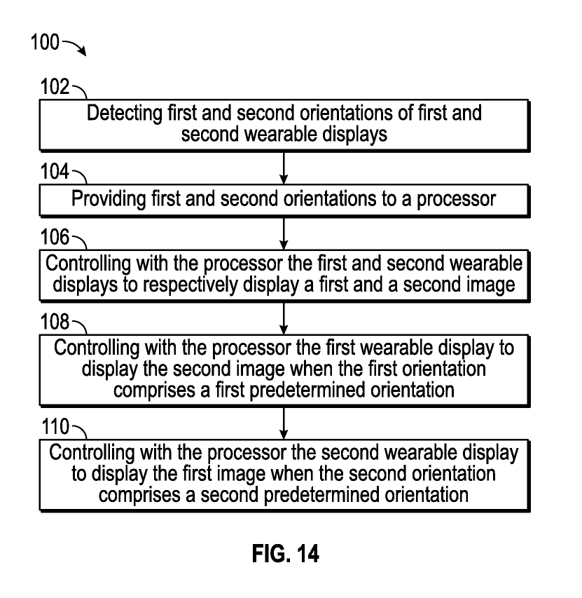

FIG. 14 is a flow diagram of an embodiment of a method 100 for facilitating instrument cross-checks between aircrew members using wearable displays. It should be understood that although the steps of method 100 are depicted in a serial fashion, the sequence of any/all of the steps of method 100 may be varied without departing from the teachings of the present disclosure.

At step 102, a first orientation of a first wearable display is detected and a second orientation of a second wearable display is detected. This step may be accomplished by employing any of a number of suitable sensors including, but not limited to accelerometers and/or gyroscopes mounted or otherwise associated with each wearable display, or with external sensors located proximate each wearable display and configured to detect orientation. For example, such external sensors may comprise a magnetic field detector, a video camera, or any other type of sensor configured to determine the orientation of a wearable display from a remote location.

At step 104, the first and second orientations are provided by the sensors to a processor. In some embodiments, the sensors may be configured to automatically provide the orientations continuously or periodically while in other embodiments, the sensors may provide the orientations in response to an interrogation or a command issued by the processor.

At step 106, the processor controls the first wearable display to display a first image containing flight-related information originating from a first source(s) and further controls the second wearable display to display a second image containing flight-related information originating from a second source(s). Such information may include, but is not limited to a heading, a flight level, and a velocity of the aircraft.

At step 108, the processor controls the first wearable display to display the second image when the processor determines that the first orientation is equal to a first predetermined orientation. Similarly, at step 110, the processor controls the second wearable display to display the first image when the processor determines that the second orientation is equal to a second predetermined orientation. This has the effect of showing each aircrew member what the other aircrew member is looking at. In this manner, method 100 facilitates cross-checking between aircrew members wearing wearable displays by detecting when one aircrew member is looking at a predetermined location in the flight deck, interpreting this as a desire by that aircrew member to see what the other aircrew member is currently viewing, and then showing that aircrew member what the other aircrew member is looking at.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the disclosure as set forth in the appended claims.

What is claimed is:

1. A system for facilitating instrument cross-checks between aircrew members using wearable displays, the system comprising:
a first wearable display configured to be worn by a first aircrew member;
a second wearable display configured to be worn by a second aircrew member;
a first sensor configured to detect a first orientation of the first wearable display;
a second sensor configured to detect a second orientation of the second wearable display; and
a processor communicatively coupled with the first sensor, the second sensor, the first wearable display and the second wearable display, the processor configured to:
obtain the first orientation from the first sensor
obtain the second orientation from the second sensor,
control the first wearable display to display a first image to the first aircrew member,
control the second wearable display to display a second image to the second aircrew member, and
control the first wearable display to display the second image to the first aircrew member when the first orientation comprises a first predetermined orientation.

2. The system of claim 1, wherein the first wearable display and the second wearable display each comprises a near-to-eye device.

3. The system of claim 2, wherein the first wearable display and the second wearable display each comprises a helmet mounted display.

4. The system of claim 2, wherein the first wearable display and the second wearable display each comprises a visor.

5. The system of claim 2, wherein the first wearable display and the second wearable display each comprises a pair of goggles.

6. The system of claim 2, wherein the first wearable display and the second wearable display each comprises a monocle.

7. The system of claim 1, wherein the first sensor and the second sensor are associated with the first wearable display and the second wearable display, respectively.

8. The system of claim 7, wherein the first sensor and the second sensor each comprises an accelerometer.

9. The system of claim 7, wherein the first sensor and the second sensor each comprises a gyroscope.

10. The system of claim 1, wherein the first sensor and the second sensor are associated with a flight deck.

11. The system of claim 1, wherein the first image comprises a first set of flight related data and the second image comprises a second set of flight related data.

12. The system of claim 11, wherein the first set of flight related data is derived from a first instrument and the second set of flight related data is derived from a second instrument.

13. The system of claim 1, wherein the first predetermined orientation is an orientation that causes a predetermined location in a flight deck to fall within sight line of the first aircrew member.

14. The system of claim 13, where the predetermined location comprises a location on an instrument panel disposed directly in front of the second aircrew member.

15. The system of claim 1, wherein the processor is further configured to control the second wearable display to present the first image to the second aircrew member when the second orientation comprises a second predetermined orientation.

16. The system of claim 1, further comprising a user input device, wherein the processor is communicatively coupled with the user input device and wherein the processor is configured to control the first wearable display to present the second image to the first aircrew member when the first orientation comprises the first predetermined orientation and when the user input device is actuated.

17. The system of claim 1, further comprising a user input device, wherein the processor is communicatively coupled with the user input device and wherein the processor is configured to control the first wearable display to discontinue presentation of the second image to the first aircrew member when the first orientation comprises the first predetermined orientation and when the user input device is actuated.

18. A system for facilitating instrument cross-checks between aircrew members using wearable displays, the system comprising:
a first wearable display configured to be worn by a first aircrew member;
a second wearable display configured to be worn by a second aircrew member;
a sensor configured to detect a first orientation of the first wearable display and a second orientation of the second wearable display; and
a processor communicatively coupled with the sensor, the first wearable display and the second wearable display, the processor configured to:
obtain the first orientation and the second orientation from the sensor,
control the first wearable display to display a first image to the first aircrew member,
control the second wearable display to display a second image to the second aircrew member, and
control the first wearable display to display the second image to the first aircrew member when the first orientation comprises a first predetermined orientation.

19. The system of claim 18, wherein the first sensor and the second sensor each comprises one of a video camera and a magnetic field sensor.

20. A method for facilitating instrument cross-checks between aircrew members using wearable displays, the method comprising the steps of:
Detecting a first orientation of a first wearable display and a second orientation of a second wearable display;
providing the first orientation and the second orientation to a processor;
controlling, with the processor, the first wearable display to display a first image and the second wearable display to display a second image; and
controlling, with the processor, the first wearable display to display the second image when the first orientation comprises a first predetermined orientation.
